(19) United States
(12) Patent Application Publication
(10) Pub. No.: US 2013/0092748 A1
(43) Pub. Date: Apr. 18, 2013

(54) HOSE ATTACHMENT PARTICULATE SPREADER

(71) Applicants: Thomas Waggoner, Maumee, OH (US); Mario Restive, Maumee, OH (US); Tom Remms, Maumee, OH (US); Mark Graham, Maumee, OH (US); Steve Domik, Maumee, OH (US)

(72) Inventors: Thomas Waggoner, Maumee, OH (US); Mario Restive, Maumee, OH (US); Tom Remms, Maumee, OH (US); Mark Graham, Maumee, OH (US); Steve Domik, Maumee, OH (US)

(73) Assignee: The Andersons, Inc., Maumee, OH (US)

(21) Appl. No.: 13/690,949

(22) Filed: Nov. 30, 2012

Related U.S. Application Data
(63) Continuation of application No. 13/508,446, now abandoned.
(60) Provisional application No. 61/258,872, filed on Nov. 6, 2009.

(51) Int. Cl. B05B 7/14

(52) U.S. Cl. CPC B05B 7/149
USPC 239/10; 239/417.5; 239/315

(57) ABSTRACT

A hose attachment particulate spreader device is provided that includes a housing having a particulate egress aperture. A first funnel channel is provided for conveying dry flowable particulate. A selector controls a first gate in communication with the first funnel channel. The first gate meters dry flowable particulate within the first funnel channel. A water inlet is also provided for engaging a water supply hose. A water trigger is included for simultaneously opening a second gate in communication with the first gate and the egress aperture, as well as applying a water spray to exhaust a content from the funnel hose out the egress aperture. A process for field spreading is provided that includes attaching a bottle to such a device, the bottle containing a content of a dry flowable particulate or a slurry. The device is coupled to a water supply hose and by exhausting a water spray from the water supply hose through the device to exhaust a portion of the content while the content remaining in the bottle does not contact the water spray and remains in an unchanged form.

### CROSS-REFERENCE TO RELATED APPLICATION

This application is a continuation of U.S. utility application Ser. No. 13/508,446 filed May 7, 2012 that in turn is a US national phase application of PCT/US10/55858 filed Nov. 8, 2010 that in turn claims priority of U.S. Provisional Patent Application Ser. No. 61/258,872 filed Nov. 6, 2009, these priority filings are hereby incorporated herein by reference.

### FIELD OF THE INVENTION

The present invention relates in general to a device for spreading and in particular to such a device spreading dry flowable particulate in a wet form or a slurry through resort to a hose to power the device and avoid hazards of conventional spray or dry particulate application.

### BACKGROUND OF THE INVENTION

The application of pesticides or fertilizers requires a level of skill to avoid off-target drift, avoid liquid spills which are hazardous and impractical to recover, to maintain concentration control during mixing and application, and to ensure that just the right amount of mixture is produced, which avoids having leftovers or running out of product before the job is done, These problems are compounded in small-area consumer applications in which the user lacks both the skill and equipment associated with professional farmers or groundskeepers. As a result, many consumer-based pesticide or fertilizer products are formulated as granules that are less hazardous to handle and not prone to environmental hazards associated with off-target drift and spillage. Some particulate formulations of pesticides and/or fertilizers work best when applied to wet turf, or should be watered in following application, either of which adds an extra level of complexity to the application. A remaining problem associated with such particulate is user handling of the material as well as subsequent to the application the possibility of mower pickup or unintended ingestion or contact with wildlife, pets, or humans. While prior art attempts have been made to use a pelletized material that is applied through a hose water jet, such devices have met with limited acceptance owing to the requirement that the particulate be wholly soluble as insoluble material tended to clog discharge tubes associated therewith.

Thus, there exists a need for a device capable of spreading particulate or a slurry such as pesticide, fertilizer, mulch, or seed as a hose attachment. There further exists a need for such a device that includes a closed system limiting user exposure to particulate material to be spread. There further exists a need for a device that makes it convenient and simple to wet the product and the treated area as the application is made and/or to wash the product into the soil immediately after the application for best results. There further exists a need for such a device that allows unused material to be stored for later use in a dried state.

### SUMMARY OF THE INVENTION

A hose attachment particulate spreader device is provided that includes a housing having a particulate egress aperture. A first funnel channel is provided for conveying dry flowable particulate. A selector controls a first gate in communication with the first funnel channel. The first gate meters dry flowable particulate within the first funnel channel. A water inlet is also provided for engaging a water supply hose. A water trigger is included for simultaneously opening a second gate in communication with the first gate and the egress aperture, as well as applying a water spray to exhaust a content from the funnel hose out the egress aperture. A process for field spreading is provided that includes attaching a bottle to such a device, the bottle containing a content of a dry flowable particulate or a slurry. The device is coupled to a water supply hose and by exhausting a water spray from the water supply hose through the device to exhaust a portion of the content while the content remaining in the bottle does not contact the water spray and remains in an unchanged form.

### BRIEF DESCRIPTION OF THE DRAWINGS

FIG. 1 is a longitudinal cross-sectional view of an inventive spreader;

FIG. 2A is a magnified inset of the flow mechanism within the spreader shown in FIG. 1;

FIG. 2B is a transverse cross-sectional view of the inset of FIG. 2A along line IIB-IIB;

FIG. 2C is a cross-sectional view of alternate channel arrangements relative to FIG. 2B;

FIG. 3 is a perspective view of a bottle for use with the device of FIG. 1;

FIGS. 4A and 4B are perspective views of a bottle cap of the bottle shown in FIG. 3 in (A) an open position and (B) a closed position;

FIG. 5 is a perspective view of the bottle cap of FIG. 4B as viewed through a transparent bottle;

FIG. 6 is a transverse cross-sectional view of the bottle cap of FIG. 4B in an operational orientation; and

FIG. 7 is a top view of a bottle cap for metering product to a central chamber of the device of FIG. 1.

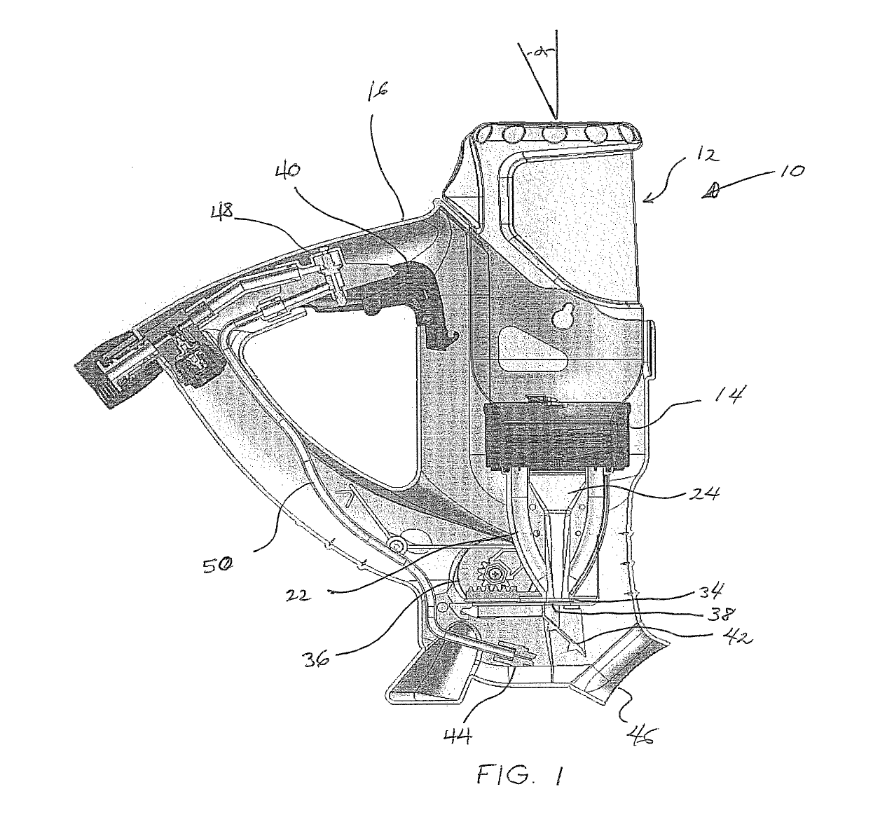

### DETAILED DESCRIPTION OF THE PREFERRED EMBODIMENTS

The present invention has utility as a spreader device powered by a pressurized hose for the delivery of a dry flowable particulate or a slurry. The present invention reliably regulates the flow of either a seed/mulch mixture through a first flow chamber or applies a second type of particulate or slurry such as fertilizer granules, pesticide granules, or a combination thereof that is reliably metered through a different chamber into a flow of a spray nozzle. With a pre-packaged particulate or slurry having a bottle cap that preferentially regulates the flow of particulate into a given flow chamber path, a user need not experience physical contact with the product or adjust settings to adequately meter the product onto soil.

Referring now to the figures where like numerals used within various figures correspond to the same structures, an inventive device is shown generally at 10 for spreading particulate material. The device 10 engages a bottle 12, the bottle 12 having a bottle cap 14. The components of device 10, bottle 12, and cap 14 are each independently formed from a variety of materials conventional to the art that illustratively include metals, glass, and plastics. Preferably one of the aforementioned components is formed of a plastic. More preferably one of the aforementioned components is formed of a thermoplastic material. Most preferably, at least one component of device 10 and the bottle 12 is formed of thermoplastic material. As will be subsequently detailed, preferably the bottle cap 14 is retained in a closed position upon engaging the remainder of the device 10 and upon a certain rotation, the bottle cap 14 engages the remainder of the device 10 thereby also shifting the bottle cap 14 into an open position. It is appreciated that user contact with bottle contents is precluded through a device-cap engagement that causes cap 14 to open. The device 10 has a housing 16 adapted to engage the bottle cap 14 as well as a water hose (not shown). The housing 16 is readily formed from a variety of materials including steel, aluminum, thermoplastics, and a combination thereof. The device 10 is adapted to receive the bottle 12 in an inverted orientation such that the granular contents of a bottle 12 will feed into the device 10 by way of gravity. While the bottle 12 is depicted in the accompanying figures with a vertical bottle axis, it is appreciated that a bottle axis at angles a of between 0 and 60 degrees is suitable to provide a gravity feed of particulate to the device 10. A bottle cap 14 is provided with apertures 18 or 20 that upon bringing the bottle cap 14 into an open position overlap at least a first funnel channel as depicted in the figure embodiments as a peripheral funnel 22 channel or a central funnel channel 24, respectively. Preferably, a given bottle cap 14 has either apertures 18 or apertures 20 to regulate the flow of particulate from within a bottle 12 through an inventive device 10 to preclude clogging. Although peripheral funnel channel 22 is particularly well suited for a predetermined shape and size of either fertilizer or pesticide granular particulate, the central funnel channel 24 is well suited for metering the delivery of an irregular mixture of seed and/or mulch. It is appreciated that many seed types are oblate in shape and tend to clog a conventional funnel thereby requiring the inclusion of a mechanical auger.

The central funnel channel 24 is shaped to cause a mulch and/or seed mixture to continually collapse through the channel 24. Preferably, the channel 24 has a vertical side wall 26 positioned above a focusing side wall 28. The focusing side wall 28 transitions to an expanding side wall section 30. Optionally, intermediate between the focusing side wall section 28 and expanding side wall section 30, a choke section 32 is provided to align oblate and other aspherical particulate transiting therethrough. Preferably, the vertical extent of vertical side wall section 26 has the same vertical extent as the focusing side wall section 28 plus or minus 50%. Additionally, it is preferred that the expanding side wall section 30 has a vertical extent of twice that of the focusing side wall section 28 plus or minus 50%. The central funnel channel 24 is readily formed of the same materials as housing 16.

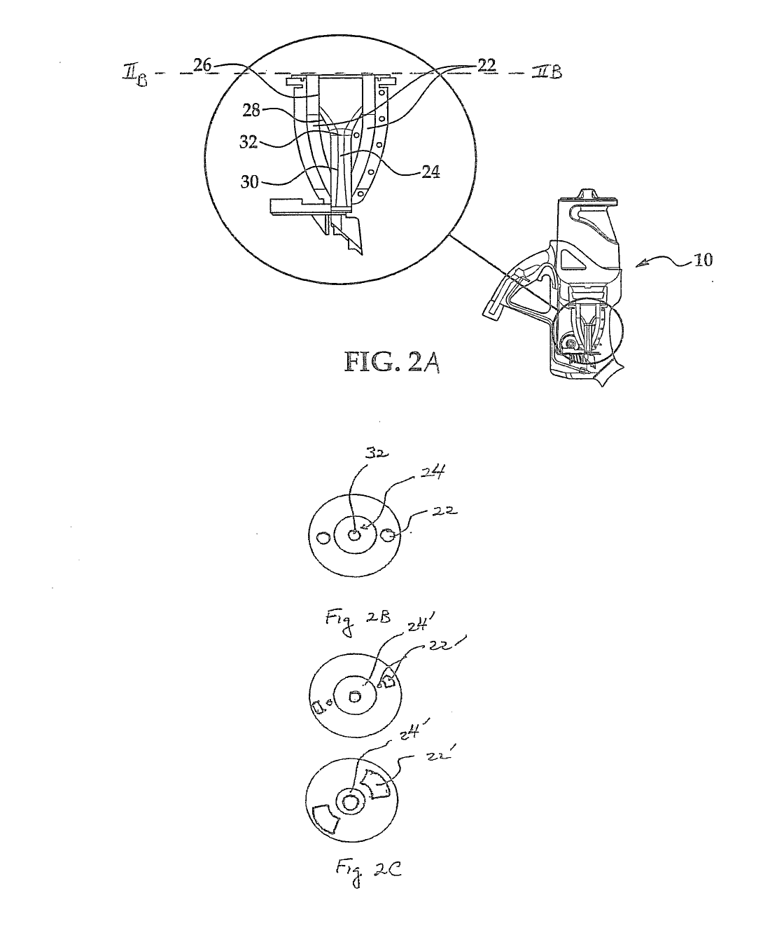

The peripheral funnel channel 22 is optionally replicated to include two, three, four, five, six, or more such channels to assure a feed of granules therethrough regardless of the tilt of the inventive device 10. Preferably, between two and four peripheral funnel channels 22 are present in an inventive device 10 with corresponding apertures 20 being provided in bottle cap 14. It is appreciated that alternate sets of peripheral funnel channels 22 are provided that vary in diameter and are designed to be used with differing bottle caps 14 so as to use different sized particulate in each separate set of peripheral funnel channels 22. For visual simplicity, a single set of peripheral funnel channels 22 is shown in the accompanying FIGS. 2A and 2B. The multiple channels 22 are provided around channel 24 in other arrangements as depicted collectively in FIG. 2C. It is appreciated that the channels 22′ vary in number, shape, and dimensions relative to channels 22. Channel 24′ is also readily modified in shape and dimensions relative to channel 24.

Optionally included on the device is a knob that mechanically switches the particulate flow “on” or “off so the unit may be conveniently used to simply spray water for irrigation, for example when it is desirable to disperse, dissolve, and/or thoroughly “water in” the applied product for best results.

Regardless of the configuration of funnel channels 22 and 24 through which contents of bottle 12 flow, the channel engages an upper gate 34 (synonymously referred to herein as a first gate). The upper gate 34 is selectively shifted between open and closed positions through manual engagement of a selector 36. While the selector 36 is depicted in the accompanying figures as a knob that upon rotation displaces the upper gate 34, it is appreciated that the selector 36 includes a variety of conventional forms including a slide and an apertured wheel. With the selector 36 shifted into an open position, the contents of bottle 12 drop through the bottle cap 14 through either channel 22 or 24 and come into contact with a lower gate 38 (synonymously referred to herein as a second gate). The lower gate 38 is brought into an open position through engagement of a water trigger 40. With the lower gate 38 in an open position, the contents of bottle 12 are then free to drop into contact with a chute 42. The material falling from the chute 42 contacts a stream of water exiting the spray nozzle 44 to create a wet particulate stream that exits the inventive device 10 through aperture 46.

The spray nozzle 44 is also activated by the water trigger 40. The water trigger 40 upon appropriate movement opens a water valve 48 sending a pressurized stream of water through water tube 50 that extends between the water valve 48 and the spray nozzle 44. The water valve 48 is in fluid communication with a conventional water hose connected to an inventive device 10 through water inlet 52. Optionally, a pressure regulator 53 is provided that affords a constant watenparticulate mix ratio. The pressure regulator 53 optionally has a velocity control that precludes operation when flow is below a preselected value.

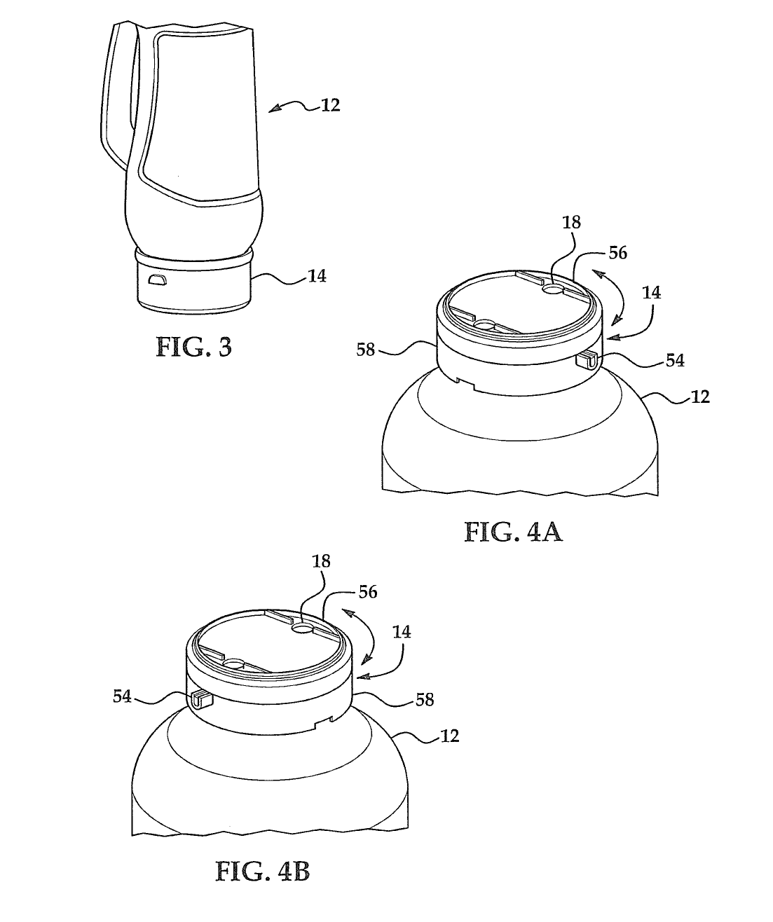

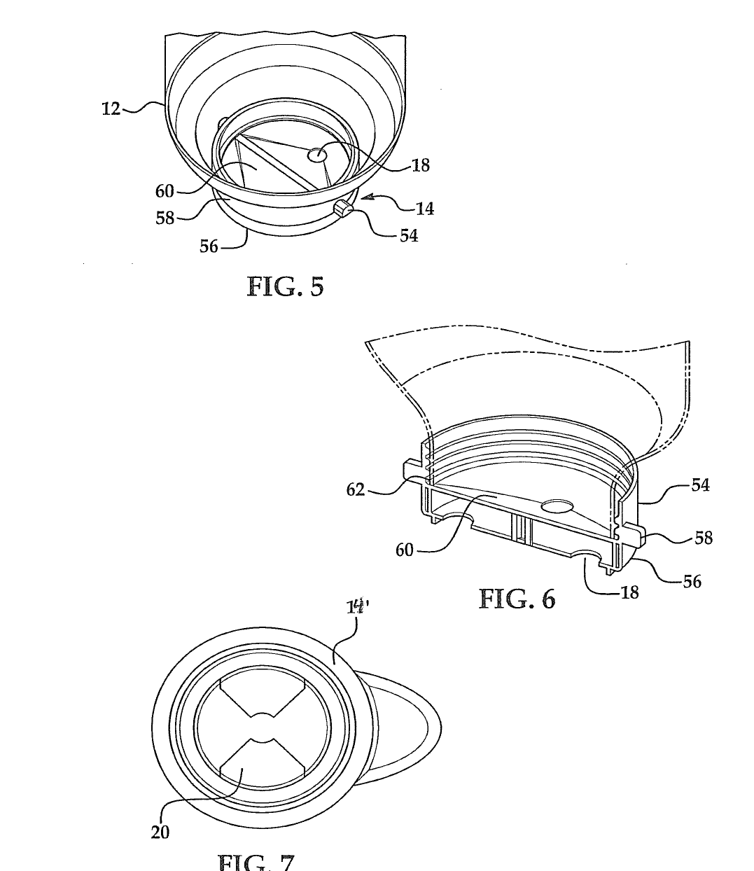

A bottle cap 14 having apertures 18 and adapted to convey particulate from within a bottle 12 through a pair of geometrically opposed peripheral funnel channels 22 is shown with greater detail in FIGS. 3-6. Preferably, the bottle cap 14 has at least one key 54 that engages a corresponding portion within the housing 16 such that upon a preselected rotation of the bottle cap 14, the key 54 creates fluid communication between the aperture 18 and the interior of the bottle 12. As shown in FIGS. 4A and 4B, a 90 degree rotation of the key 54 rotates the bottle cap 14 from a closed (FIG. 4B) to an open (FIG. 4A) position. The bottle cap 14 has a rotatable head 56 that moves relative to a cap base 58 from which the key 54 extends. Preferably, the cap base 58 has a particulate contacting inner surface 60 that slopes towards the apertures 18 upon securement within the housing 16 so as to facilitate gravity feed of particulate through the apertures 18. Preferably, the bottle cap components are formed of a thermoplastic material. The cap 14 engages the mouth 62 of the bottle 12 with conventional structures. While the engagement between the mouth 62 and the cap 14 as depicted in the figures shows complementary threads, it is appreciated that alternate engagements include pressure fit, contact adhesives, and sonic welding. The bottle 12 is preferably formed of recyclable thermoplastic material. The bottle 12 upon being emptied of contents is readily detached and discarded. Preferably, the bottle 12 closes the cap 14 simultaneous with detachment thereby precluding user contact with the contents such as dry flowable particulate.

A top view of a bottle cap for metering contents of a bottle 12 to central funnel channel 24 is provided FIG. 7 and has central apertures 20 to provide fluid communication between the contents of the bottle 12 and the central funnel channel 24 upon engagement of bottle cap 14′ with an inventive housing 16. Other than the position and dimensioning of apertures 20 relative to apertures 18, bottle cap 14′ is otherwise identical to bottle cap 14.

The foregoing description is illustrative of particular embodiments of the invention, 10 but is not meant to be a limitation upon the practice thereof. The following claims, including all equivalents thereof, are intended to define the scope of the invention.

1. A hose attachment spreader device comprising:
a housing having an egress aperture;
a first funnel channel;
a selector controlled first gate in communication with said first funnel channel;
a water inlet for engaging a water supply hose;
a second gate in communication with said first gate and the egress aperture; and a water trigger for simultaneously opening said second gate and applying a water spray to exhaust a content from said funnel channel out the egress aperture.

2. The device of claim 1 wherein said first funnel channel is a central funnel channel.

3. The device of claim 2 further comprising a peripheral funnel channel.

4. The device of claim 1 wherein said first gate is located at a terminus of said first funnel channel.

5. The device of claim 1 wherein said second gate is located at a terminus of said first funnel channel.

6. The device of claim 1 further comprising a bottle supplying dry flowable particulate or a slurry to said first funnel channel.

7. The device of claim 6 further comprising a bottle cap having a cap aperture, said cap rotating to an open position upon engagement with said housing to form particulate communication between said bottle and said first funnel channel.

8. The device of claim 7 wherein said bottle cap has a cap base having a key extending therefrom and a rotating cap head.

9. The device of claim 8 wherein said cap base has a particulate contacting inner surface tapering towards the cap aperture.

10. The device of claim 1 wherein said first funnel channel has a vertical side wall section, a focusing side wall section, an expanding side wall section, and a vertically descending order and operating orientation.

11. The device of claim 10 wherein the height of the vertical side wall section is the same as the focusing side wall section height within 50%.

12. The device of claim 10 wherein the expanding side wall section has an expanding side wall section height that is twice the focusing side wall section height within 50%.

13. The device of claim 1 and lacking an augur to convey particulate to the particulate egress aperture.

14. The device of claim 1 further comprising a pressure regulator for maintaining a preselected ratio between the water spray and the particulate.

15. A process for field spreading comprising:
attaching a bottle containing a content of a dry flowable particulate or slurry to the device of claim 1;
engaging the device of claim 1 with a water supply hose; and
exhausting a water spray from the water supply hose through the device of claim 1 to exhaust a portion of the content while the content remaining in said bottle does not contact the water spray and remains in an unchanged form.

16. The process of claim 15 further comprising opening said bottle simultaneous with said attaching step.

17. The process of claim 15 further comprising discarding said bottle.

18. The process of claim 15 wherein the portion of the contents is gravity fed into the water spray.

19. The process of claim 15 further comprising selectively preventing the portion of the content from contacting the water spray.
